(19) United States
(12) Patent Application Publication
(10) Pub. No.: US 2024/0275519 A1
(43) Pub. Date: Aug. 15, 2024

(54) Training Network-Based Decoders of User Equipment (UE) Channel State Information (CSI) Feedback

(71) Applicant: Telefonaktiebolaget LM Ericsson (publ), Stockholm (SE)

(72) Inventors: Roy Timo, Kungsängen (SE); Rakesh Ranjan, Järfälla (SE); Henrik Rydén, Stockholm (SE); Xinlin Zhang, Västra Frölunda (SE); Mattias Frenne, Uppsala (SE)

(21) Appl. No.: 18/567,397

(22) PCT Filed: Jun. 22, 2022
(86) PCT No.: PCT/SE2022/050620

§ 371 Date: Dec. 6, 2023

Related U.S. Application Data
(60) Provisional application No. 63/215,081, filed on Jun. 25, 2021.

(51) Int. Cl. H04L 1/00; H04B 7/06; H04W 24/02; H04W 24/10

(52) U.S. Cl. CPC H04L 1/0026; H04B 7/0626; H04W 24/02; H04W 24/10

(57) ABSTRACT

Embodiments include methods for a radio access network (RAN) node. Such methods include transmitting downlink (DL) reference signals (RS) in accordance with one or more configurations and receiving, from each of one or more user equipment (UEs), feedback representing a DL channel from the RAN node to the UE. The feedback is based on the UE's measurements of the transmitted DL RS and is encoded by one or more UE encoders that correspond to respective RAN node decoders. Such methods include, for each of the one or more UEs, obtaining one or more measurements of uplink (UL) RS transmitted by the UE in accordance with the one or more configurations. Such methods include training the RAN node decoder(s) based on the received feedback and the obtained UL RS measurements. Other embodiments include complementary methods for UEs, as well as RAN nodes and UEs configured to perform such methods.

### TECHNICAL FIELD

The present invention generally relates to wireless networks, and more specifically to techniques for training network-based decoders of user equipment (UE)-encoded feedback about a downlink (DL) channel from the wireless network to the UE, such as when the network decoder and/or UE encoder use artificial intelligence (AI) and/or machine learning (ML) techniques.

### BACKGROUND

Long-Term Evolution (LTE) is an umbrella term for so-called fourth-generation (4G) radio access technologies developed within the Third-Generation Partnership Project (3GPP) and initially standardized in Release 8 (Rel-8) and Release 9 (Rel-9), also known as Evolved UTRAN (E-UTRAN). LTE is targeted at various licensed frequency bands and is accompanied by improvements to non-radio aspects commonly referred to as System Architecture Evolution (SAE), which includes Evolved Packet Core (EPC) network. LTE continues to evolve through subsequent releases.

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases. NR was initially specified in 3GPP Release 15 (Rel-15) and continues to evolve through subsequent releases, such as Rel-16 and Rel-17.

5G/NR technology shares many similarities with LTE. For example, NR uses CP-OFDM (Cyclic Prefix Orthogonal Frequency Division Multiplexing) in the downlink (DL) from network to user equipment (UE), and both CP-OFDM and DFT-spread OFDM (DFT-S-OFDM) in the uplink (UL) from UE to network. As another example, NR DL and UL time-domain physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, rather than a fixed 15-KHz OFDM sub-carrier spacing (SCS) as in LTE, NR SCS can range from 15 to 240 kHz, with even greater SCS considered for future NR releases.

In addition to providing coverage via cells as in LTE, NR networks also provide coverage via “beams.” In general, a DL (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

5G/NR networks are expected to operate at higher frequencies such as 5-60 GHZ, which are typically referred to as “millimeter wave” or “mmW” for short. Such systems are also expected to utilize a variety of multi-antenna technology (e.g., antenna arrays) at the transmitter, the receiver, or both. In general, multi-antenna technology can include a plurality of antennas in combination with advanced signal processing techniques (e.g., beamforming). Multi-antenna technology can be used to improve various aspects of a communication system, including system capacity (e.g., more users per unit bandwidth per unit area), coverage (e.g., larger area for given bandwidth and number of users), and increased per-user data rate (e.g., for given bandwidth and area).

Availability of multiple antennas at the transmitter and/or the receiver can be utilized in different ways to achieve different goals. For example, multiple antennas at the transmitter and/or the receiver can be used to provide additional diversity against radio channel fading. To achieve such diversity, the channels experienced by the different antennas should have low mutual correlation, e.g., a sufficiently large antenna spacing (“spatial diversity”) and/or different polarization directions (“polarization diversity”).

As another example, multiple antennas at the transmitter and/or the receiver can be used to shape or “form” the overall antenna beam (e.g., transmit and/or receive beam, respectively) in a certain way, with the general goal being to improve the received signal-to-interference-plus-noise ratio (SINR) and, ultimately, system capacity and/or coverage. This can be done, for example, by maximizing the overall antenna gain in the direction of the target receiver or transmitter or by suppressing specific dominant interfering signals. More specifically, the transmitter and/or receiver can determine an appropriate weight for each antenna element in an antenna array so as to produce one or more beams, with each beam covering a particular range of azimuth and elevation relative to the antenna array.

In relatively good channel conditions, the capacity of the channel becomes saturated such that further improving the SINR provides limited capacity improvements. In such cases, using multiple antennas at both the transmitter and the receiver can be used to create multiple parallel communication “channels” over the radio interface. This can facilitate a highly efficient utilization of both the available transmit power and the available bandwidth resulting in, e.g., very high data rates within a limited bandwidth without a disproportionate degradation in coverage. For example, under certain conditions, the channel capacity can increase linearly with the number of antennas and avoid saturation in the data capacity and/or rates. These techniques are commonly referred to as “spatial multiplexing” or multiple-input, multiple-output (MIMO) antenna processing.

Accordingly, spatial multiplexing is a key feature to increase the spectral efficiency of wireless networks, including 5G/NR. Transmitting multiple layers on the same time-frequency resource can increase the data-rate for a single user (referred to as “SU-MIMO”). Alternatively, transmitting multiple layers on the same time-frequency resource to multiple users (referred to as “MU-MIMO”) can increase the system capacity in terms of number of users.

More specifically, a multi-antenna radio access network (RAN) node (e.g., base station) with N_{TX} antenna ports simultaneously transmits information to several UEs using the same OFDM time-frequency resources. Before modulation and transmission, a precoding matrix W_{V}^{(j)} is applied to sequence S⁽ⁱ⁾ transmitted to user (or UE) i for spatial separation from other transmissions and mitigation of multiplexing interference. Each UE(i) demodulates its received signal and combines receiver antenna signals in order to obtain an estimate Ŝ⁽ⁱ⁾ of sequence S⁽ⁱ⁾ transmitted to it. In general, the precoder W_{V}^{(j)} should correlate well with channel H⁽ⁱ⁾ observed by UE(i) and it should correlate poorly with the channels observed by other UEs.

To construct precoders that enable efficient MU-MIMO transmissions, the RAN node needs to acquire detailed knowledge of the DL channels H(i). In deployments where channel reciprocity holds, detailed channel knowledge can be acquired from UL sounding reference signals (SRS) that are transmitted periodically, or on demand, by active UEs. Based on these SRS, the RAN node can directly estimate the UL channel and, therefore, the DL channel H⁽ⁱ⁾.

However, the RAN node cannot always accurately estimate the DL channel from UL SRS. In such cases, active UEs need to feedback channel information to the RAN node. In LTE and NR, a RAN node periodically transmits DL CSI-RS from which the UE estimates the DL channel. The UE reports CSI feedback to the RAN node over an UL channel, e.g., physical UL control channel (PUCCH) or physical UL shared channel (PUSCH). The RAN node uses the UE's feedback to select suitable precoders for DL MU-MIMO transmissions. The CSI feedback mechanism from the UE to the RAN node or network targeting MU-MIMO operations in NR is referred to as CSI Type II reporting.

### SUMMARY

Recently neural network based autoencoders (NNAEs) have shown promising results for compressing DL channel estimates for UL feedback by the UE. An AE is a type of artificial neural network (NN) that can be used to compress data in an unsupervised manner. These networks are trained to compress and reconstruct data (e.g., channel estimates) with high fidelity.

For various reasons, NNAE-based CSI feedback is of interest for 3GPP Rel-18 and beyond. However, there are various problems, issues, and/or difficulties with NNAE-based CSI feedback, particularly in networks having equipment from multiple vendors or suppliers (referred to as “multi-vendor” or “open” networks).

Embodiments of the present disclosure provide specific improvements to NNAE-based CSI feedback in wireless networks, such as by providing, enabling, and/or facilitating solutions to overcome exemplary problems summarized above and described in more detail below.

Embodiments include methods (e.g., procedures) for a radio access network (RAN) node (e.g., base station, eNB, gNB, ng-eNB, etc. or component thereof).

These exemplary methods can include transmitting DL RS in accordance with one or more configurations and receiving, from each of one or more UEs, feedback representing a DL channel from the RAN node to the UE. The feedback is based on the UE's measurements of the transmitted DL RS and is encoded by one or more UE encoders that correspond to respective RAN node decoders. These exemplary methods can also include obtaining one or more measurements of UL RS transmitted by the UE in accordance with the one or more configurations. These exemplary methods can also include training the one or more RAN node decoders based on the received feedback and the obtained UL RS measurements.

In some embodiments, these exemplary methods can also include sending the one or more configurations to the one or more UEs. Each configuration includes the following: a first configuration for UE measurement of DL RS transmitted by the RAN node, a second configuration for UE transmission of UL RS, and an identifier of one of the UE encoders. For example, the DL RS can be CSI-RS and the UL RS can be SRS.

In some of these embodiments, these exemplary methods can also include receiving, from each of the one or more UEs, an indication of UE DL channel feedback encoding capabilities. In some variants, the indication comprises at least one identifier of an encoder supported by the UE, including the one or more identifiers included in the respective configurations. In other variants, encoders supported by the UE are indicated by one or more of the following: UE vendor, UE model, UE chipset vendor, and UE chipset model.

In some of these embodiments, these exemplary methods can also include, for each of the one or more UEs, obtaining estimates of one or more UL channels from the UE to the RAN node based on the UL RS measurements. In such case, training the one or more RAN node decoders is based on the UL channel estimates for the respective UEs.

In some of these embodiments, each second configuration identifies a plurality of symbols of a single timeslot for UE transmission of UL RS. In such case, obtaining the measurements of UL RS in can include, for each of the one or more UEs, receive the UL RS transmitted by the UE during the plurality of symbols using a respective plurality of different RAN node antennas. Moreover, obtaining estimates of one or more UL channels from the UE to the RAN node can include obtaining estimates of a plurality of UL channels corresponding to the respective plurality of different RAN node antennas.

In some embodiments, these exemplary methods can also include receiving from a second RAN node a training dataset for a plurality of decoders of UE DL channel feedback and selectively training the one or more RAN node decoders based the received training dataset. In various embodiments, selectively training the one or more decoders can include one of more of the following operations:
training only the RAN node decoders that correspond to encoder identifiers included in the received training dataset;
training the RAN node decoders only based on portions of the received training dataset that are associated with channel characteristics similar to channel characteristics measured by the RAN node; and
training the RAN node decoders based on the received training dataset only when the second RAN node has an antenna array configuration that is similar to the RAN node's antenna array configuration.

In some embodiments, training the one or more RAN node decoders can include the following operations for each of the one or more UEs:
determining an importance weight based on a duration between transmitting the DL RS and obtaining the one or more measurements of UL RS transmitted by the UE; and
adjusting, in proportion to the importance weight, effect on the training of the UE's feedback representing the DL channel and of the measurements of UL RS transmitted by the UE.

In some embodiments, these exemplary methods can also include sending to each of the one or more UEs a command to initiate UE measurement of the DL RS and UE transmission of the UL RS, based on the one or more configurations.

In some embodiments, one or more of the following applies:
the one or more UE encoders are not trained during the training of the corresponding one or more RAN node decoders;
the one or more UE encoders are fixed or configured as non-trainable; and
the one or more UE encoders and the corresponding one or more RAN node decoders are part of respective one or more AEs.

In some of these embodiments, the one or more UE encoders include a plurality of UE encoders corresponding to a plurality of RAN node decoders. In some variants, the transmitting, receiving, obtaining, and training operations are performed for each of the RAN node decoders in sequence.

In other variants, transmitting the DL RS and obtaining the measurements of the UL RS transmitted by the UE are performed once for the plurality of RAN node decoders, and the received feedback is encoded by the plurality of UE encoders based on the UE's measurements of the DL RS. In these variants, training the plurality of RAN node decoders can be performed in parallel based on the encoded UE feedback. In some further variants, the received feedback encoded by each UE encoder includes a different number of bits than the received feedback encoded by other UE encoders.

In some embodiments, these exemplary methods can also include, using a trained RAN node decoder, estimating an UL channel from one of the UEs to the RAN node based on further feedback from the UE that represents the DL channel from the RAN node to the UE and that is encoded by a UE encoder corresponding to the trained RAN node decoder.

In some embodiments, these exemplary methods can also include, using a trained RAN node decoder, determining one or more beam directions for a DL channel from the RAN node to one of the UEs, based on further feedback from the UE that represents the DL channel from the RAN node to the UE and that is encoded by a UE encoder corresponding to the trained RAN node decoder.

Other embodiments include methods (e.g., procedures) for a UE configured to communicate with a RAN. These exemplary methods are complementary to the exemplary methods for a RAN node, summarized above.

These exemplary methods can include obtaining one or more measurements of DL RS transmitted by a RAN node in accordance with one or more configurations. These exemplary methods can also include sending to the RAN node feedback representing a DL channel from the RAN node to the UE. The feedback is based on the DL RS measurements and is encoded by one or more UE encoders that correspond to respective RAN node decoders. These exemplary methods can also include transmitting UL RS in accordance with the one or more configurations.

In some embodiments, the DL RS are CSI-RS and the UL RS are SRS. Specifically, the SRS are transmitted using the same SRS port-to-physical antenna mapping as the physical antenna-to-baseband port mapping used to receive the measured CSI-RS.

In some embodiments, one or more of the following applies:
the one or more UE encoders are not trained during training of the corresponding one or more RAN node decoders;
the one or more UE encoders are fixed or configured as non-trainable; and
the one or more UE encoders and the corresponding one or more RAN node decoders are part of respective one or more neural network autoencoders (NNAE).

In some embodiments, the feedback representing the DL channel is used to train the one or more RAN node decoders to perform one or more of the following: estimate an UL channel from the UE to the RAN node; and determine one or more beam directions for the DL channel. In some of these embodiments, these exemplary methods can also include, after the one or more RAN node decoders have been trained, transmitting further feedback that represents the DL channel and that is encoded by one of the UE encoders that corresponds to a trained RAN node decoder.

In some embodiments, these exemplary methods can also include receiving the one or more configurations from the RAN node. Each configuration includes a first configuration for UE measurement of DL RS transmitted by the RAN node, a second configuration for UE transmission of UL RS, and an identifier of one of the UE encoders.

In some of these embodiments, these exemplary methods can also include sending to the RAN node an indication of UE DL channel feedback encoding capabilities. In some variants, the indication comprises at least one identifier of an encoder supported by the UE, including the one or more identifiers included in the respective configurations. In other variants, encoders supported by the UE are indicated by one or more of the following: UE vendor, UE model, UE chipset vendor, and UE chipset model. In such embodiments, the one or more configurations received from the RAN node can be based on the indicated UE capabilities.

In some of these embodiments, the second configuration identifies a plurality of symbols of a single timeslot and the UL RS are transmitted in the plurality of symbols using respective UE antenna configurations that correspond to a plurality of different RAN node antennas.

In some embodiments, these exemplary methods can also include receiving from the RAN node a command to initiate UE measurement of the DL RS and UE transmission of the UL RS based on the one or more configurations based on the first configuration. In such case, transmitting the UL RS and measuring the DL RS are responsive to the command.

In some embodiments, the one or more UE encoders include a plurality of UE encoders corresponding to a plurality of RAN node decoders. In some variants, the obtaining, sending, and transmitting operations are performed for each of the UE encoders in sequence. In other variants, obtaining the measurements of the DL RS and transmitting the UL RS are performed once for the plurality of UE encoders, and the feedback is encoded by the plurality of UE encoders based on the measurements of the DL RS. In some further variants, the feedback encoded by each UE encoder includes a different number of bits than the feedback encoded by other UE encoders.

Other embodiments include RAN nodes (e.g., base stations, eNBs, gNBs, ng-eNBs, etc., or components thereof) and UEs (e.g., wireless devices, IoT devices, etc., or components thereof) configured to perform operations corresponding to any of the exemplary methods described herein. Other embodiments include non-transitory, computer-readable media storing program instructions that, when executed by processing circuitry, configure such RAN nodes or UEs operations corresponding to any of the exemplary methods described herein.

These and other embodiments can embodiments can facilitate machine learning (ML)-based CSI feedback using proprietary encoders and decoders, thereby improving MU-MIMO that relies on CSI feedback. Neither the UE's encoder nor the network's decoder needs to be standardized, and their respective architectures and/or parameters can be kept proprietary. The network can train, validate, and test CSI decoders using datasets generated from UL SRS channel estimates and UE CSI reports. These trained decoders can then facilitate replacing UE-specific UL SRS resources with cell-common DL CSI-RS resources, and thus can reduce reference signal transmission overhead. Due to these advantages, embodiments can improve the overall performance of MU-MIMO used to transmit DL data to multiple UEs concurrently.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows a block diagram of an exemplary MU-MIMO arrangement.

FIG. 2 shows beams of a 32-vector DFT beamforming codebook covering an orientation range of +/−90 degrees.

FIG. 3 illustrates type II CSI feedback, as further described in 3GPP TS 38.214 (v 16.5.0).

FIG. 4 illustrates a fully connected neural network autoencoder (NNAE) architecture.

FIG. 5 illustrates an exemplary application of NNAEs to MIMO transmission.

FIG. 6 shows an exemplary signaling procedure for training a CSI report decoder in a network, according to various embodiments of the present disclosure.

FIG. 7 shows a flow diagram of an exemplary method for a RAN node (e.g., base station, eNB, gNB, ng-eNB, etc.), according to various embodiments of the present disclosure.

FIG. 8 shows a flow diagram of an exemplary method for UE (e.g., wireless device, etc.) of a wireless network, according to various embodiments of the present disclosure.

FIG. 9 illustrates a high-level views of an exemplary 5G/NR network architecture.

FIG. 10 shows a communication system according to various embodiments of the present disclosure.

FIG. 11 shows a UE according to various embodiments of the present disclosure.

FIG. 12 shows a network node according to various embodiments of the present disclosure.

FIG. 13 shows host computing system according to various embodiments of the present disclosure.

FIG. 14 is a block diagram of a virtualization environment in which functions implemented by some embodiments of the present disclosure may be virtualized.

FIG. 15 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where a step must necessarily follow or precede another step due to some dependency. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:
Radio Node: As used herein, a “radio node” can be either a radio access node or a wireless device.”
Node: As used herein, a “node” can be a network node or a wireless device.
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Some examples of a wireless device include, but are not limited to, smart phones, mobile phones, cell phones, voice over IP (VOIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc. Unless otherwise noted, the term “wireless device” is used interchangeably herein with the term “user equipment” (or “UE” for short).
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

As briefly mentioned above, NNAE-based CSI feedback by UEs is of interest for 3GPP Rel-18 and beyond to support MU-MIMO DL transmissions by networks. However, there are various problems, issues, and/or difficulties with AE-based CSI feedback solutions, particularly in networks having equipment from multiple vendors or suppliers (referred to as “multi-vendor” or “open” networks). This is discussed in more detail below.

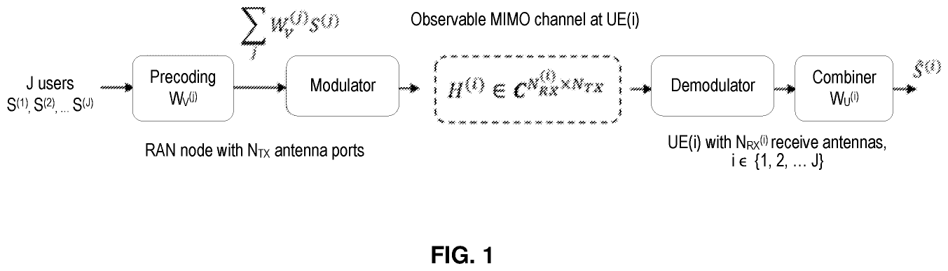

FIG. 1 shows a block diagram of an exemplary MU-MIMO transmission arrangement. a multi-antenna RAN node (e.g., base station) with N_{TX} antenna ports simultaneously transmits information to several UEs using the same OFDM time-frequency resources. For example, sequence S⁽¹⁾ is transmitted to UE(1), S⁽²⁾ is transmitted to UE(2), and so on. Before modulation and transmission, a precoding matrix W_{V}^{(j)} is applied to sequence S⁽ⁱ⁾ transmitted to user (or UE) i for spatial separation from other transmissions and mitigation of multiplexing interference.

Each UE(i) demodulates its received signal and combines receiver antenna signals in order to obtain an estimate Ŝ⁽ⁱ⁾ of sequence S⁽ⁱ⁾ transmitted to it. Note the order of modulation and precoding, or demodulation and combining respectively, may differ from FIG. 1 depending on the specific implementation of MU-MIMO transmission. In general, the precoder W_{V}⁽ⁱ⁾ should correlate well with channel H⁽ⁱ⁾ observed by UE(i) and it should correlate poorly with the channels observed by other UEs. This estimate Ŝ⁽ⁱ⁾ can be expressed as:

$${\hat{S}}^{( i )} = {\underbrace{{W}_{U}^{( i )} {H}^{( i )} {W}_{V}^{( i )}}}_{\approx I} {S}^{( i )} + {W}_{U}^{( i )} {H}^{( i )} {\sum }_{j , j \neq i} {W}_{V}^{( j )} {S}^{( j )}$$

The second term represents the spatial multiplexing interference seen by UE(i). The goal for the RAN node is to construct the set of precoders {W_{V}^{(j)}} to meet one or more targets, such as to make:
the norm ∥H⁽ⁱ⁾W_{V}⁽ⁱ⁾∥ large, since this norm represents the desired channel gain towards user i); and
the norm ∥H^{(j)}W_{V}⁽ⁱ⁾∥, j≠i small, since this norm represents the interference of user i's transmission received by user j.
   In other words, the precoder W_{V}⁽ⁱ⁾ should correlate well with the channel H⁽ⁱ⁾ observed by UE(i) while correlating poorly with the channels observed by other UEs.

To construct precoders that enable efficient MU-MIMO transmissions, the RAN node needs to acquire detailed knowledge of the DL channels H(i). In deployments where reciprocity exists between UL and DL channels, detailed channel knowledge can be acquired from UL SRS that are transmitted periodically, or on demand, by active UEs. Based on these SRS, the RAN node can directly estimate the UL channel and, therefore, the DL channel H⁽ⁱ⁾ by reciprocity.

However, the RAN node cannot always accurately estimate the DL channel from UL reference signals. For example, in frequency division duplex (FDD) deployments, the UL and DL channels use different carriers and, therefore, the UL channel might not provide enough information about the DL channel to enable MU-MIMO precoding. Additionally, the RAN node may only be able to estimate part of the UL channel. For example, the UE has fewer TX branches than RX branches, in which case only certain columns of the precoding matrix can be estimated using UL SRS.

If the RAN node cannot estimate the DL channel from UL transmissions, then active UEs need to feedback channel information to the RAN node. In LTE and NR, a RAN node periodically transmits DL CSI-RS from which the UE estimates the DL channel. The UE reports CSI feedback to the RAN node over an UL channel, e.g., physical UL control channel (PUCCH) or physical UL shared channel (PUSCH). The RAN node uses the UE's feedback to select suitable precoders for DL MU-MIMO transmissions. The CSI feedback mechanism from the UE to the RAN node or network targeting MU-MIMO operations in NR is referred to as CSI Type II reporting.

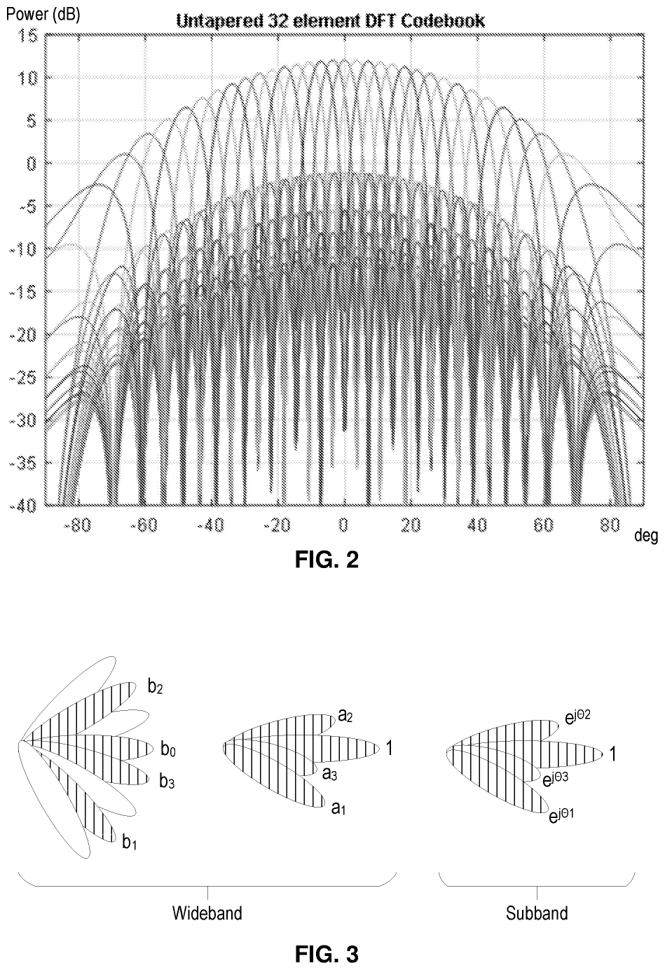

Normal Type II CSI reporting is based on the specification of sets of DFT basis functions (also referred to as “grid of beams”) in a precoder codebook. In general, the DFT basis functions (or vectors) provide a set of beams equally spaced in orientation over a range of interest. This arrangement provides the narrowest beam and also full utilization of power amplifiers (PAs), but at the expense of high sidelobes. FIG. 2 illustrates the grid of beams for a 32-element DFT codebook covering an azimuth range of +/−90 degrees, where the maximum sidelobe for each beam is 13 dB below the peak for that beam.

The UE selects and reports the L DFT vectors from the codebook that best match its channel conditions. This approach is similar to precoding matrix indicator (PMI) from earlier 3GPP releases. The number L is configurable but is typically 2 or 4. The UE also reports how the L DFT vectors should be combined in terms of relative amplitude scaling and co-phasing. In general, each DFT vector corresponds to a beam, particularly when the RAN node has a uniform planar array with antenna elements separated by less than half of the carrier wavelength. Based on this technical context, the terms “DFT vector” and “beam” are used synonymously herein unless expressly stated otherwise or a different meaning is clear from a particular context of use.

FIG. 3 illustrates CSI type II feedback mode, which is further described in 3GPP TS 38.214 (v 16.5.0). The selection and reporting of the L DFT beam vectors bₙ and their relative amplitudes aₙ is done in a wideband manner, i.e., the same beams are used for both polarizations over the whole band. However, the selection and reporting of the beam co-phasing coefficients is done in a sub-band manner, i.e., co-phasing parameters are determined for each of multiple subsets of contiguous subcarriers. The co-phasing parameters are quantized such that e^{jθ}^{ₙ} is taken from either a QPSK or 8PSK signal constellation. With k denoting a sub-band index, the precoder reported by the UE can be expressed as:

$${W}_{V} [ k ] = {\sum }_{n} {b}_{n} {a}_{n} {e}^{j {θ}_{n} [ k ]} .$$

The Type II CSI report can be used by the RAN node to spatially co-schedule multiple UEs on the same OFDM time-frequency resources. For example, the RAN node can select UEs that have reported different sets of beams or beams that have weak correlations. The CSI Type II report enables the UE to report a precoder hypothesis that trades CSI resolution for reduced UL transmission overhead.

NR Rel-15 also supports Type II CSI feedback using port selection. In this case, the RAN node transmits a CSI-RS port in each of the beam directions but the UE does not use a codebook to select a DFT vector (or beam). Instead, the UE selects one or multiple antenna ports from the CSI-RS resource of multiple ports. Type II CSI feedback using port selection gives the RAN node some flexibility to use non-standardized precoders, which are transparent to the UE. For the port-selection codebook, the precoder reported by the UE can be described as:

$${W}_{V} [ k ] = {\sum }_{n} {b}_{n} {a}_{n} {e}^{j {θ}_{n} [ k ]} .$$

where e is a unit vector with only one non-zero element and can be viewed a “selection vector” that selects a port from the set of ports in the measured CSI-RS resource. The UE thus feeds back which ports it has selected, the amplitude factors, and the co-phasing factors.

Recently NNAEs have shown promising results for compressing DL channel estimates for UL feedback by the UE. As briefly mentioned above, an NNAE is a type of artificial neural network (NN) that can be used to compress data in an unsupervised manner. These networks are trained to compress and reconstruct data (e.g., channel estimates) with high fidelity.

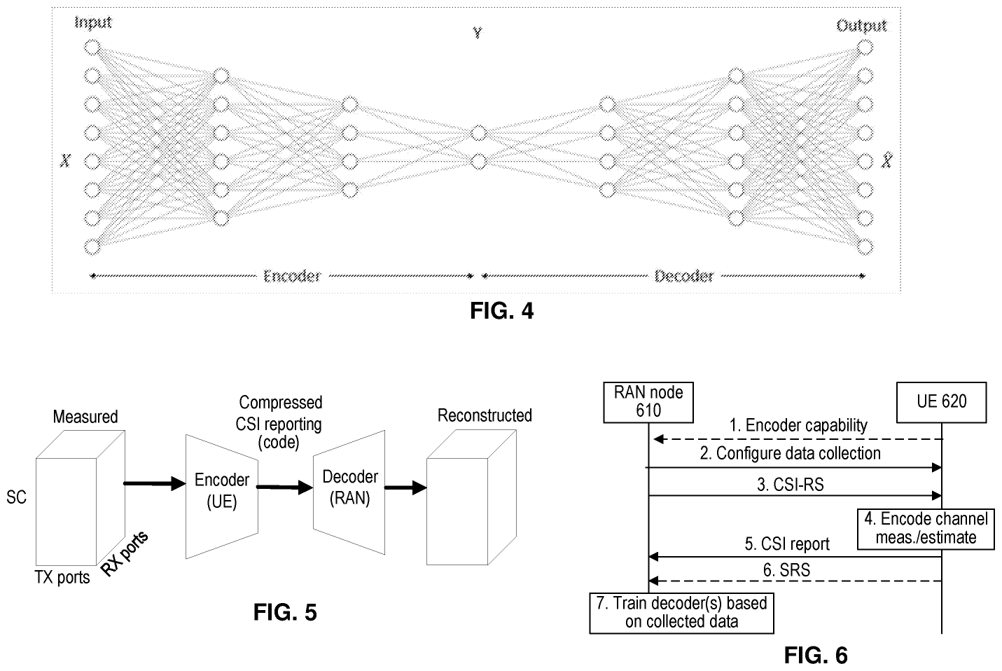

FIG. 4 illustrates a simple fully connected (dense) NNAE architecture. This exemplary AE is divided into two parts: an encoder (located in the UE), and a decoder (located in the network, e.g., RAN node). The output of the encoder (so-called “bottleneck layer” of the NNAE) represents the codeword that is to be signaled from the UE to the network over the UL. The codeword can be viewed as a sequence of latent variables, which describe the latent representation of the channel.

In addition to the fully-connected (dense) architecture show in FIG. 4, NNAEs can be based on other fully-connected NNs, multi-dimensional convolution NNs, recurrent NNs, or any combination thereof. However, all NNAE architectures have the encoder-bottleneck-decoder structure illustrated in FIG. 4. The size of the codeword (denoted Y in FIG. 4) of an NNAE is typically much smaller than the size of the input data (X in FIG. 4). The encoder reduces the dimensionality of the input features with increasing depth of the neural network. The decoder essentially tries to invert the encoder and reconstruct the original input data with minimal error (according to some predefined loss function).

The architecture of an NNAE (e.g., number of layers) typically needs to be numerically optimized for the specific application (e.g., channel compression) via a process called hyperparameter tuning. Properties of the data (e.g., CSI-RS channel estimates), the channel size, uplink feedback rate, and hardware limitations of the encoder and decoder all need to be considered when optimizing the NNAE's architecture.

The weights and biases of an NNAE (with a fixed architecture) are trained to minimize the error between the input X and reconstructed output \hat{X} (“reconstruction error”) on some training dataset. For example, the weights and biases can be trained to minimize the mean squared error (MSE) (X−\hat{X})². Model training is typically done using a variant of the gradient descent algorithm on a large data set. The training data set should be representative of the actual data the NNAE will encounter during live operation. The process of designing an NNAE (hyperparameter tuning and model training) is typically expensive—consuming significant time, compute, memory, and power resources.

For various reasons, NNAE-based CSI feedback by UEs is of interest for 3GPP Rel-18 and beyond to support MU-MIMO DL transmissions by networks. As an example, NNAEs can include non-linear transformations (e.g., activation functions) that help improve compression performance and, therefore, MU-MIMO performance for the same UL overhead. In contrast, the normal Type II CSI codebooks in Rel-15 and Rel-16 are based on linear DFT transformations and SVD decompositions, which cannot fully exploit redundancies in the channel for compression.

NNAEs can also be trained to exploit long-term redundancies in the propagation environment and/or site (e.g., antenna configuration) for compression purposes. For example, a particular NNAE does not need to work well for all possible deployments. Improved compression performance is obtained by learning which channel inputs it needs to (and doesn't need to) reliably reconstruct at the base-station.

NNAEs can also be trained to compensate for antenna array irregularities, such as non-uniformly and/or non-half wavelength element spacing. In contrast, the Type II CSI codebooks in Rel-15 and Rel-16 use a two-dimensional DFT codebook designed for a regular planar array with perfect half wavelength element spacing.

NNAEs can also be updated (e.g., via transfer learning and training) to compensate for failing hardware as the product ages. For example, over time Tx and Rx radio chains will fail compromising the effectiveness of Type II CSI feedback.

FIG. 5 illustrates an exemplary application of NNAEs to MIMO transmission. The UE measures the channel in the downlink using CSI-RS. The UE estimates that channel for each OFDM subcarrier (SC) from each RAN node TX antenna and at each UE RX antenna. The estimate can be viewed as a three-dimensional (3D) channel matrix or tensor. The 3D channel matrix representing the MIMO channel estimated over several subcarriers is input to the encoder.

For compression of UL CSI reports for the DL channel, the encoder is implemented in the UE and the decoder is implemented in the network (e.g., RAN node). It is also possible to reverse the CSI reporting operation, such that the RAN node measures the UL channel using UE transmitted SRS and reports uplink CSI to the UE using an NNAE encoder. The UL channel can then be reconstructed by the UE using the corresponding NNAE decoder.

Despite potentially offering improved performance, NNAE-based CSI feedback solutions can have various problems, issues, and/or difficulties, particularly for implementation in multi-vendor or open networks. In general, a UE's encoder can be a complicated NN with thousands of tunable parameters (e.g., weights and biases). The UE's compute and energy resources are limited, and, therefore, the encoder will likely need to be known in advance to the UE. For example, the encoder's architecture will need to match the UE's hardware, and the model (with weights and biases possibly fixed) will need to be compiled with appropriate optimizations. The process of compiling the encoder can be costly in time, compute, power, and memory resources. Moreover, the compilation process requires specialized software tool chains to be installed and maintained on each UE. Due to these factors, UE vendors may want proprietary NNAE encoders, designed and deployed offline to UEs using proprietary data and technology, outside the network's knowledge and control.

For NNAE-based CSI feedback to work well, the network will need to have an appropriate decoder for each UE encoder. Moreover, the decoder will need to be trained on appropriate channel data using either the UE's encoder directly or an emulator of the UE's encoder. In other words, the network vendor will need to have access to the UE's encoder in explicitly or operationally (e.g., via an emulator) to train its decoder.

One solution to the above problem is to standardize the UE's encoder, so that it is known to all relevant parties (e.g., UE and network vendors). This solution, however, does not allow UE vendors competitive advantage. Another solution is for the UE vendor to share its encoder with the network vendor. This solution, however, does not allow an open multi-vendor standardization framework.

Embodiments of the present disclosure address these and other problems, issues, and/or difficulties by providing techniques for the network to train, validate, and/or test CSI decoders corresponding to CSI encoders employed in UEs, which may be otherwise proprietary (as discussed above). In particular, the network can train, validate, and/or test a decoder on one or more datasets that are generated by logging the UE's encoded and/or compressed CSI reports together with the network's channel estimates based on UL SRS transmissions by the UE. CSI-RS and/or SRS transmissions arranged specifically for this purpose can be used. The data logging procedure can be done online (e.g., in live network operation), in drive tests, or offline.

During the training phase, the network can train the decoder to reconstruct the network's SRS channel estimates using only the UE's compressed CSI-RS channel estimate (i.e., output of the UE's encoder in a CSI report) as input. The network can then deploy the trained decoder in the network to operate as needed with the UE encoder, which may be given a unique identifier that is known to both UE and network. During normal operation phase, the network can refrain from requesting UL SRS transmissions by the UE, since the network's decoder has been trained to reconstruct UL channel estimates based on actual CSI reports received from the UE during normal operation.

Embodiments of the present disclosure can provide various benefits, advantages, and/or solutions to various problems. At a high level, embodiments facilitate machine learning (ML)-based CSI feedback using proprietary encoders and decoders. The UE's encoder does not need to be standardized, such that its architecture and/or parameters can be kept proprietary from other parties, including the network. Likewise, the network's decoder can remain proprietary and does not need to be standardized. The network trains, validates, and tests the decoder using datasets generated from SRS channel estimates and UE CSI reports. The decoder's architecture and parameters (e.g., weights and biases) do not need to be revealed to the UE or other parties. Furthermore, a well-trained encoder-decoder pair can facilitate replacing UE-specific UL SRS resources with common or shared DL CSI-RS resources, and thus can reduce reference signal overhead.

Various embodiments will now be described in more detail. In general, embodiments are relevant to the scenario in which UE vendors deploy proprietary encoders to compress CSI-RS based channel estimates (e.g., encoder in FIG. 5). Each UE vendor may have one or more proprietary encoders, e.g., one per UE model, one per chipset model, one per software version, etc. Each encoder is assigned a unique identifier (ID), which is made public. However, the encoder's trained parameters (e.g., weights and biases) remain proprietary and are not revealed to networks or other UE vendors. Moreover, the encoder's architecture does not need to be known by the network.

Alternately, in some embodiments, the particular encoder ID can be inferred from UE vendor, UE model, chipset vendor, chipset model, etc. In other words, encoder ID is implicit from one or more of these characteristics.

In some embodiments, a UE may have multiple such CSI encoders, and may select a different one of the encoders depending on the configured CSI report type, etc.

In some embodiments, the network collects data by configuring the UE with one or more CSI-RS resources, one or more SRS resources, and NNAE-based CSI reporting. This data will be used to train the network's decoder for the UE's encoder. This can be done during a training phase in live network operation or during a drive test. The data collection in the training phase can be done periodically or occasionally, and data can be collected from many UEs using the same encoder and across multiple cells that may different propagation characteristics.

FIG. 6 shows an exemplary procedure for training a CSI report decoder in a radio access network (RAN), according to various embodiments of the present disclosure. The illustrated procedure is between a RAN node (610, e.g., base station) and a UE (620). Although certain operations shown in FIG. 6 are given numerical labels, these are intended to facilitate explanation rather than to require any particular operational order, unless expressly stated or clearly implied by the context. Optional operations are indicated by dashed lines.

In operation 1, the UE sends an encoder capability report to the RAN node. This can be done, for example, in conjunction with the UE joining, connecting to, and/or registering with the RAN node. This report can indicate the UE's ML model capabilities for CSI encoding. This can be indicated, for example, by including a particular encoder ID or an equivalent representation of this ID. In general, operation 1 can but is not required to occur before the RAN node configures the UE's CSI reporting mode. Note that operation 1 is shown as optional because the particular encoder ID can be inferred in some cases from UE vendor, UE model, chipset vendor, chipset model, etc.

In operation 2, the RAN node configures the UE for data collection. This can be based on the encoder capabilities received in operation 1, but this information is not strictly required for operation 2. This configuration can include CSI-RS resources to be measured by the UE and a CSI reporting procedure. In some embodiments, the RAN node can configure the UE CSI-RS resources and a legacy CSI reporting mode. For example, the RAN node can configure the UE to report Rel-15 Type I or II, or Rel-16 Enhanced Type II.

In other embodiments, the RAN node can configure the UE with CSI-RS resources and an ML-based CSI reporting model, i.e., for the UE to use its encoder to compress its CSI-RS based channel estimate. As a variant, the RAN node can also configure the UE with UL SRS resources for reciprocity (denoted “AntennaSwitching” in 3GPP specifications). The network can select the configured CSI-RS and SRS resources jointly to maximize correlation between the measured DL and UL channels, respectively.

In operation 3, the RAN node transmits CSI-RS according to the configuration sent in operation 2, and the UE determines a DL channel estimate based on the UE's measurements of the received CSI-RS. In operation 4, the UE encodes the measurements and/or DL channel estimate. This encoding can be done according to legacy (e.g., Rel-15 and Rel-16) methods or based on using NNAE techniques described herein. The encoding can also be responsive to the configuration in operation 2. In operation 5, the UE transmits a CSI report to the RAN node including the encoded channel measurements and/or estimate.

In operation 6, the UE transmits UL SRS if configured by the RAN node to do so (e.g., in operation 2), and the RAN node performs measurements of the received UL SRS and, optionally, determines an estimate of the UL channel from the UE based on the measurements. Note that operation 6 may occur before operation 3, depending on implementation. Assuming that the UE is configured for SRS transmission (operation 6) and ML-based CSI reporting (operation 5), then the RAN node can collect the following training data:
Encoder ID (e.g., reported by UE in operation 1),
UE's compressed CSI-RS channel feedback (e.g., reported by UE in operation 5), and
RAN node's SRS-based UL channel measurements and/or estimate (e.g., made in operation 6).
   This collected data is used for training the decoder in operation 7.

In some embodiments, the training can be based on data collected for multiple UEs that are served by the RAN node, e.g., in a cell. In some embodiments, multiple logs from different UEs and cells can be combined into larger datasets for training, validating, and testing decoders. In various embodiments, datasets can be collated over one or more UE's (using the same encoders), over multiple days, and over multiple cell sites using the same antenna array.

In some embodiments, the network's decoder training can include determining a mapping or relationship between UE CSI feedback for DL channels to and the network's UL channel estimates based on SRS. In other words, the network trains each decoder to estimate the UL channel from the UE's CSI compressed CSI-RS-based DL channel estimate. Put differently, the SRS based channel estimate is used as a proxy for the UE's CSI-RS based channel estimate, or vice versa.

In some embodiments, the decoder training procedure can use a modified version of the gradient descent algorithm that does not need to know the UE-side encoder architecture. More specifically, the back propagation algorithm used in gradient descent only needs the output of the UE encoder (via the uplink CSI report), the decoder's NN (weights and biases), and the network's SRS based channel estimate.

In some embodiments, the training procedure can include an importance weight for each dataset sample. For example, data samples with a longer time delay between CSI-RS channel feedback and SRS-based UL channel estimate can be provided with a lower importance weight in the loss calculation when training the decoder. This can allow the network to put more focus on samples where the measured DL and UL channels are more likely to be the same (e.g., with less temporal variation). As another example, the sample importance can be based on a signal quality estimate of the CSI-RS or SRS.

In some embodiments, the importance can be represented as a factor wₛ when training a decoder function ƒ that minimizes the mean-squared-error expressed as:

$$MSE = \frac{1}{N} {\sum }_{s} {{w}_{s} ( f ( {x}_{s} ) - {y}_{true \_ s} )}^{2} .$$

In general, the above-described training strategy is different from conventional methods of training an NNAE. Conventionally, an NNAE's encoder and decoder are jointly trained to accurately reconstruct the input to the encoder at the decoder output. In contrast, embodiments of the present disclosure are based on the condition that the encoder is a fixed, UE-vendor proprietary model and only the decoder is trained to reconstruct an approximation of the encoder input (i.e., UL SRS channel, as a proxy for the DL CSI-RS channel).

In some embodiments, the UE vendor deploys multiple encoders in individual UEs. Each UE can then indicate all available encoders to the network (e.g., in operation 1 of FIG. 6). The network selects one of the available encoders and, optionally, may indicate the selection to the UE (e.g., in operation 2 of FIG. 6). The network may choose to train a decoder for the selected encoder and will in this case configure SRS transmissions and a CSI report for that particular encoder (e.g., also in operation 2).

In some embodiments, the network can train one decoder at a time, in which case the network may indicate the selection to the UE. Alternatively, the UE is configured to report CSI for multiple encoders simultaneously (e.g., with different number of feedback bits), the network can concurrently train decoders for multiple available UE encoders.

In some embodiments, certain aspects of the encoder architecture can be specified to the UE by the network. For example, this can include the number of CSI-RS ports to the number of feedback bits, or the type of encoder architecture (e.g., convolutional, fully connected, etc.). These aspects may be configured by the network, e.g., in operation 2 of FIG. 6.

In some embodiments, the decoder training can be performed in a distributed manner. As an example, a first RAN node (e.g., gNB) can receive a dataset used for training decoder(s) by a second RAN node. The first RAN node can use the dataset received from the second RAN node for training its own decoder(s). The use of the received dataset by the first RAN node can be conditioned on any of the following, individually or in any combination:
Encoder IDs, i.e., for which the first RAN node has a corresponding decoder.
Dataset similarities, e.g., based on channel delay spread statistics. In case the datasets are very different, the first RAN might not gain anything in receiving the dataset from the second RAN node, since it serves an area with a different channel environment than the area served by the first RAN node. Trying to use such data can lead to increased model complexity and/or lower decoder performance for the first RAN node. In some cases, the second RAN node can provide a subset of its dataset, from which the first RAN node to determine similarity metric(s) (e.g., Euclidian distances) with its own dataset. If the metric suggests sufficient similarity, then the first RAN node can obtain the entire dataset from the second RAN node.
Similarity of antenna array configuration.

In other embodiments, the dataset is not shared from the second RAN node to the first RAN node, but the two RAN nodes train the decoder using federated learning (FL) techniques. In general, FL (also known as collaborative learning) is an ML technique that trains an algorithm across multiple decentralized edge devices holding local data samples, without actually exchanging the data samples among the devices. The RAN nodes' decision on whether to initiate FL can be based on the dataset similarities described above.

In some embodiments, the first RAN node's decoder can be trained to reconstruct some information about the channel that is relevant for DL precoding. For example, in FDD deployments the SRS channel estimate might not accurately capture the small-scale fading state on the DL channel. In this case, the network can train the decoder to extract coarse channel information, such as the main directions/clusters, needed for a more robust precoding method (e.g., reciprocity-based grid of beams).

In some embodiments, the coarse channel information obtained from the RAN node's decoder can be combined with Type II CSI reporting, e.g., as used in 3GPP Rel-17. In this arrangement, the NNAE feedback replaces SRS in Rel-17 Type II CSI by offloading UE-specific SRS resources in favor of cell-specific CSI-RS. The RAN node transmits beamformed CSI-RS (with delay compensation) in directions identified from the UE's CSI report generated by the UE-proprietary encoder. The UE then reports co-phasing coefficients for the beamformed CSI-RS.

When a UE is relatively far away from its serving RAN node, the UL SRS coverage is relatively poor such that the UE can only transmit SRS over narrow bandwidths with some frequency hopping in between. This results in different parts of the UE's channel bandwidth being estimated at different times, such that the estimates have different degrees of “staleness” at any given time. In some embodiments, the UE could indicate this to the RAN node implicitly or using an explicit signal to show the level of fidelity. Based on this information, the RAN node could take any of the following actions:
Not use this data for training.
Use data from part of the band that has been sounded.
Use these datasets as adversarial examples in the training process. Since standard training could result in NNs that are susceptible to adversarial data, these datasets can be used when the channel is not completely true to help with robust optimization.
Fallback to legacy scheme.

Since it is important that UL and DL channel measurements are based on the same channel or at least on highly correlated channels, it is important that the UL SRS and DL CSI-RS are transmitted as close in time as possible—preferably in the same slot. In some embodiments, a new downlink control information (DCI) message type (or format) can be used to trigger a UE for both CSI-RS measurement and reporting and SRS transmission. The SRS transmission may include antenna switching to facilitate sounding all RAN node receive antennas with SRS. In such case, SRS may occupy multiple OFDM symbols in a timeslot.

This DCI trigger can be associated with an AI/ML training mode for joint CSI-RS/SRS, such that UE is aware that the triggered SRS is used for reciprocity/antenna switching purpose. Accordingly, the UE will transmit SRS using the same SRS port-to-physical antenna mapping as the physical antenna-to-baseband port mapping that it uses to receive CSI-RS, thereby maintaining channel reciprocity between UL and DL. Other types of commands, such as MAC CE, can be used for this purpose instead of DCI.

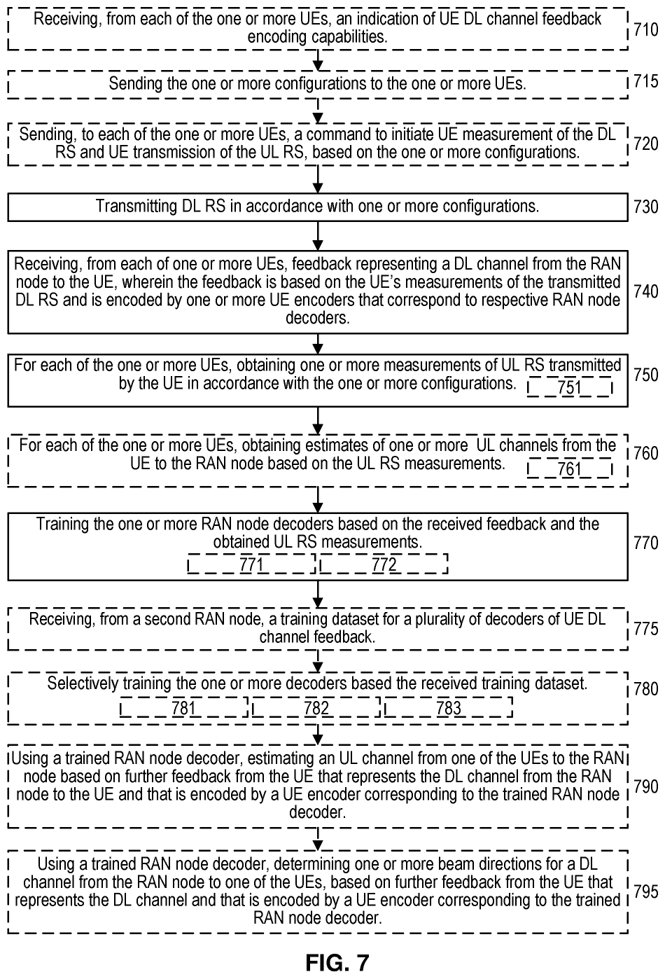

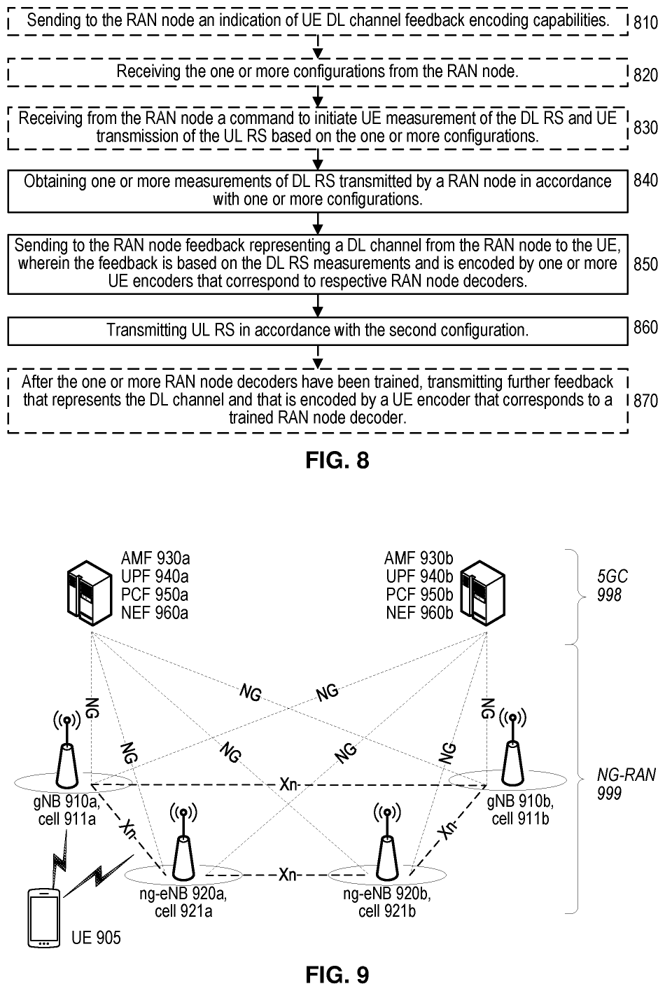

The embodiments described above can be further illustrated with reference to FIGS. 7-8, which show exemplary methods (e.g., procedures) for a RAN node and a UE, respectively. In other words, various features of operations described below correspond to various embodiments described above. These exemplary methods can be used cooperatively to provide various exemplary benefits and/or advantages. Although FIGS. 7-8 show specific blocks in a particular order, the operations of the respective methods can be performed in different orders than shown and can be combined and/or divided into blocks having different functionality than shown. Optional blocks or operations are indicated by dashed lines. The following description also refers to certain sub-blocks that are not shown in the figures.

In particular, FIG. 7 shows a flow diagram of an exemplary method (e.g., procedure) for a radio access network (RAN) node, according to various embodiments of the present disclosure. The exemplary method can be performed by a RAN node (e.g., base station, eNB, gNB, ng-eNB, etc., or components thereof) such as described elsewhere herein.

The exemplary method can include operations of block 730, where the RAN node can transmit DL RS in accordance with one or more configurations. The exemplary method can also include the operations of block 740, where the RAN node can receive, from each of one or more UEs, feedback representing a DL channel from the RAN node to the UE. The feedback is based on the UE's measurements of the transmitted DL RS and is encoded by one or more UE encoders that correspond to respective RAN node decoders. The exemplary method can also include the operations of block 750, where for each of the one or more UEs, the RAN node can obtain one or more measurements of UL RS transmitted by the UE in accordance with the one or more configurations. The exemplary method can also include the operations of block 770, where the RAN node can train the one or more RAN node decoders based on the received feedback and the obtained UL RS measurements.

In some embodiments, the exemplary method can also include the operations of block 715, where the RAN node can send the one or more configurations to the one or more UEs. Each configuration includes the following: a first configuration for UE measurement of DL RS transmitted by the RAN node, a second configuration for UE transmission of UL RS, and an identifier of one of the UE encoders. For example, the DL RS can be CSI-RS and the UL RS can be SRS.

In some of these embodiments, the exemplary method can also include the operations of block 710, where the RAN node can receive, from each of the one or more UEs, an indication of UE DL channel feedback encoding capabilities. In some variants, the indication comprises at least one identifier of an encoder supported by the UE, including the one or more identifiers included in the respective configurations. In other variants, encoders supported by the UE are indicated by one or more of the following: UE vendor, UE model, UE chipset vendor, and UE chipset model. In such embodiments, the one or more configurations sent to the UE(s) can be based on the indicated UE capabilities.

In some of these embodiments, the exemplary method can also include the operations of block 760, where for each of the one or more UEs, the RAN node can obtain estimates of one or more UL channels from the UE to the RAN node based on the UL RS measurements (e.g., obtained in block 750). In such case, training the one or more RAN node decoders in block 770 is based on the UL channel estimates for the respective UEs.

In some of these embodiments, each second configuration identifies a plurality of symbols of a single timeslot for UE transmission of UL RS. In such case, obtaining the measurements of UL RS in block 750 can include the operations of sub-block 751, where for each of the one or more UEs, the RAN node can receive the UL RS transmitted by the UE during the plurality of symbols using a respective plurality of different RAN node antennas. Moreover, obtaining estimates of one or more UL channels from the UE to the RAN node in block 760 includes the operations of sub-block 761, where the RAN node can obtain estimates of a plurality of UL channels corresponding to the respective plurality of different RAN node antennas.

In some embodiments, the exemplary method can also include the operations of blocks 775-780, where the RAN node can receive from a second RAN node a training dataset for a plurality of decoders of UE DL channel feedback and selectively train the one or more RAN node decoders based the received training dataset. In various embodiments, selectively training the one or more decoders in block 780 can include one of more of the following operations, labelled with corresponding sub-block numbers:
(781) training only the RAN node decoders that correspond to encoder identifiers included in the received training dataset;
(782) training the RAN node decoders only based on portions of the received training dataset that are associated with channel characteristics similar to channel characteristics measured by the RAN node; and
(783) training the RAN node decoders based on the received training dataset only when the second RAN node has an antenna array configuration that is similar to the RAN node's antenna array configuration.

In some embodiments, training the one or more RAN node decoders in block 770 can include the following operations for each of the one or more UEs, labelled with corresponding sub-block numbers:
(771) determining an importance weight based on a duration between transmitting the DL RS and obtaining the one or more measurements of UL RS transmitted by the UE; and
(772) adjusting, in proportion to the importance weight, effect on the training of the UE's feedback representing the DL channel and of the measurements of UL RS transmitted by the UE.
   An example of these operations was discussed in more detail above.

In some embodiments, the exemplary method can also include the operations of block 720, where the RAN node can send to each of the one or more UEs a command (e.g., DCI command) to initiate UE measurement of the DL RS and UE transmission of the UL RS, based on the one or more configurations.

In some embodiments, one or more of the following applies:
the one or more UE encoders are not trained during the training of the corresponding one or more RAN node decoders;
the one or more UE encoders are fixed or configured as non-trainable; and
the one or more UE encoders and the corresponding one or more RAN node decoders are part of respective one or more AEs.
   Examples of these arrangements are illustrated by FIGS. 4-5.

In some of these embodiments, the one or more UE encoders include a plurality of UE encoders corresponding to a plurality of RAN node decoders. In some variants, the transmitting, receiving, obtaining, and training operations in blocks 730-750 and 770 are performed for each of the RAN node decoders in sequence.

In other variants, transmitting the DL RS (block 730) and obtaining the measurements of the UL RS transmitted by the UE (block 750) are performed once for the plurality of RAN node decoders, and the received feedback (block 740) is encoded by the plurality of UE encoders based on the UE's measurements of the DL RS. In these variants, training the plurality of RAN node decoders can be performed in parallel based on the encoded UE feedback. In some further variants, the received feedback encoded by each UE encoder includes a different number of bits than the received feedback encoded by other UE encoders.

In some embodiments, the exemplary method can also include the operations of block 790, where using a trained RAN node decoder, the RAN node can estimate an UL channel from one of the UEs to the RAN node based on further feedback from the UE that represents the DL channel from the RAN node to the UE and that is encoded by a UE encoder corresponding to the trained RAN node decoder.

In some embodiments, the exemplary method can also include the operations of block 795, where using a trained RAN node decoder, the RAN node can determine one or more beam directions for a DL channel from the RAN node to one of the UEs, based on further feedback from the UE that represents the DL channel from the RAN node to the UE and that is encoded by a UE encoder corresponding to the trained RAN node decoder.

In particular, FIG. 8 shows a flow diagram of an exemplary method (e.g., procedure) for a UE configured to communicate with a RAN, according to various embodiments of the present disclosure. The exemplary method can be performed by a UE (e.g., wireless device, IoT device, modem, etc. or component thereof) such as described elsewhere herein.

The exemplary method can include operations of block 840, where the UE can obtain one or more measurements of DL RS transmitted by a RAN node in accordance with one or more configurations. The exemplary method can also include operations of block 850, where the UE can send to the RAN node feedback representing a DL channel from the RAN node to the UE. The feedback is based on the DL RS measurements and is encoded by one or more UE encoders that correspond to respective RAN node decoders. The exemplary method can also include operations of block 860, where the UE can transmit UL RS in accordance with the one or more configurations.

In some embodiments, the DL RS are CSI-RS and the UL RS are SRS. Specifically, the SRS are transmitted (e.g., in block 860) using the same SRS port-to-physical antenna mapping as the physical antenna-to-baseband port mapping used to receive the measured CSI-RS (e.g., in block 840).

In some embodiments, one or more of the following applies:
the one or more UE encoders are not trained during training of the corresponding one or more RAN node decoders;
the one or more UE encoders are fixed or configured as non-trainable; and
the one or more UE encoders and the corresponding one or more RAN node decoders are part of respective one or more neural network autoencoders (NNAE).

In some embodiments, the feedback representing the DL channel is used to train the one or more RAN node decoders to perform one or more of the following: estimate an UL channel from the UE to the RAN node; and determine one or more beam directions for the DL channel. In some of these embodiments, the exemplary method can also include the operations of block 870, where after the one or more RAN node decoders have been trained, the UE can transmit further feedback that represents the DL channel and that is encoded by one of the UE encoders that corresponds to a trained RAN node decoder.

In some embodiments, the exemplary method can also include the operations of block 820, where the UE can receive the one or more configurations from the RAN node. Each configuration includes a first configuration for UE measurement of DL RS transmitted by the RAN node, a second configuration for UE transmission of UL RS, and an identifier of one of the UE encoders.

In some of these embodiments, the exemplary method can also include operations of block 810, where the UE can send to the RAN node an indication of UE DL channel feedback encoding capabilities. In some variants, the indication comprises at least one identifier of an encoder supported by the UE, including the one or more identifiers included in the respective configurations. In other variants, encoders supported by the UE are indicated by one or more of the following: UE vendor, UE model, UE chipset vendor, and UE chipset model. In such embodiments, the one or more configurations received from the RAN node can be based on the indicated UE capabilities.

In some of these embodiments, the second configuration identifies a plurality of symbols of a single timeslot and the UL RS are transmitted (e.g., in block 860) in the plurality of symbols using respective UE antenna configurations that correspond to a plurality of different RAN node antennas.

In some embodiments, the exemplary method can also include the operations of block 830, where the UE can receive from the RAN node a command (e.g., DCI command) to initiate UE measurement of the DL RS and UE transmission of the UL RS based on the one or more configurations based on the first configuration. In such case, transmitting the UL RS (e.g., in block 860) and measuring the DL RS (e.g., in block 840) are responsive to the command.

In some embodiments, the one or more UE encoders include a plurality of UE encoders corresponding to a plurality of RAN node decoders. In some variants, the obtaining, sending, and transmitting operations of blocks 840-860 are performed for each of the UE encoders in sequence. In other variants, obtaining the measurements of the DL RS (block 840) and transmitting the UL RS (block 860) are performed once for the plurality of UE encoders, and the feedback (e.g., sent in block 850) is encoded by the plurality of UE encoders based on the measurements of the DL RS. As mentioned above, this arrangement can facilitate training the plurality of RAN node decoders in parallel based on the encoded UE feedback. In some further variants, the feedback encoded by each UE encoder includes a different number of bits than the feedback encoded by other UE encoders.

FIG. 9 shows a high-level view of an exemplary 5G network architecture in which various embodiments of the present disclosure can be implemented. The exemplary architecture shown in FIG. 9 includes a Next Generation Radio Access Network (NG-RAN) 999 and a 5G Core (5GC) 998. As shown in the figure, NG-RAN 999 can include gNBs (e.g., 910a,b) and ng-eNBs (e.g., 920a,b) that are interconnected with each other via respective Xn interfaces. The gNBs and ng-eNBs are also connected via the NG interfaces to 5GC, more specifically to the access and mobility management functions (AMFs, e.g., 930a,b) via respective NG-C interfaces and to the user plane functions (UPFs, e.g., 940a,b) via respective NG-U interfaces. Moreover, the AMFs can communicate with one or more policy control functions (PCFs, e.g., PCFs 950a,b) and network exposure functions (NEFs, e.g., NEFs 960a,b).

Each of the gNBs can support the NR radio interface including frequency division duplexing (FDD), time division duplexing (TDD), or a combination thereof. In contrast, each of ng-eNBs can support the LTE radio interface but, unlike conventional LTE eNodeBs (eNBs), connect to the 5GC via the NG interface. Each of the gNBs and ng-eNBs can serve a geographic coverage area including one more cells, including cells 911a-b and 921a-b shown as exemplary in FIG. 9. The gNBs and ng-eNBs can also use various directional beams to provide coverage in the respective cells. For example, the gNBs and ng-eNBs can be embodiments of a RAN node configured to perform operations corresponding to the method shown in FIG. 7. Depending on the cell in which it is located, a UE 905 can communicate with the gNB or ng-eNB serving that cell via the NR or LTE radio interface, respectively. For example, UE 905 can be an embodiment of a UE configured to perform operations corresponding to the method shown in FIG. 8.

The gNBs shown in FIG. 9 can include a central (or centralized) unit (CU or gNB-CU) and one or more distributed (or decentralized) units (DU or gNB-DU), which can be viewed as logical nodes. CUs host higher-layer protocols and perform various gNB functions such controlling the operation of DUs, which host lower-layer protocols and can include various subsets of the gNB functions. As such, each of the CUs and DUs can include various circuitry needed to perform their respective functions, including processing circuitry, communication interface circuitry (e.g., for communication via Xn, NG, radio, etc. interfaces), and power supply circuitry.

A CU connects to its associated DUs over respective F1 logical interfaces. A CU and associated DUs are only visible to other gNBs and the 5GC as a gNB, e.g., the F1 interface is not visible beyond a CU. A CU can host higher-layer protocols such as F1 application part protocol (F1-AP), Stream Control Transmission Protocol (SCTP), GPRS Tunneling Protocol (GTP), Packet Data Convergence Protocol (PDCP), User Datagram Protocol (UDP), Internet Protocol (IP), and Radio Resource Control (RRC) protocol. In contrast, a DU can host lower-layer protocols such as Radio Link Control (RLC), Medium Access Control (MAC), and physical-layer (PHY) protocols. Other variants of protocol distributions between CU and DU are also possible.

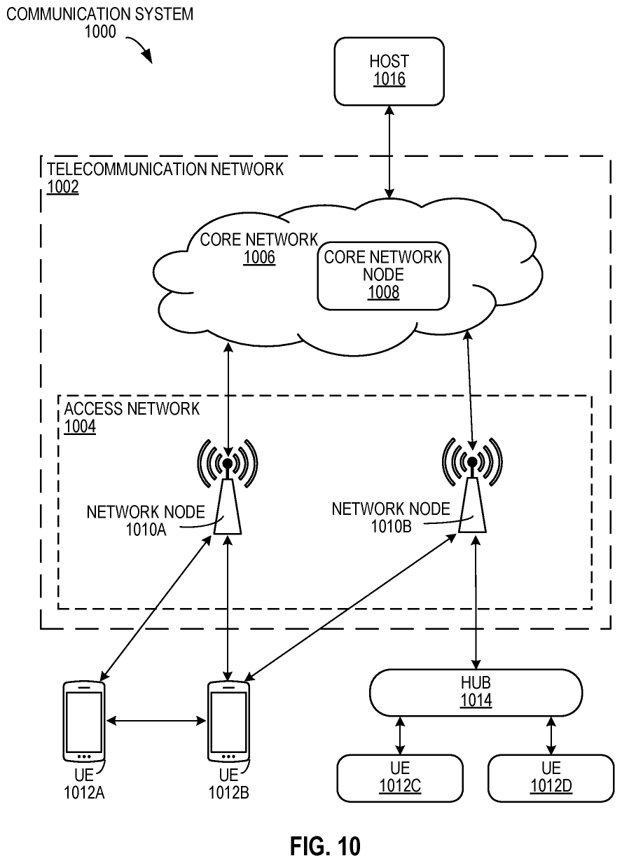

FIG. 10 shows an example of a communication system 1000 in accordance with some embodiments. In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3GPP access node or non-3GPP access point. The network nodes 1010 facilitate direct or indirect connection of UEs, such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

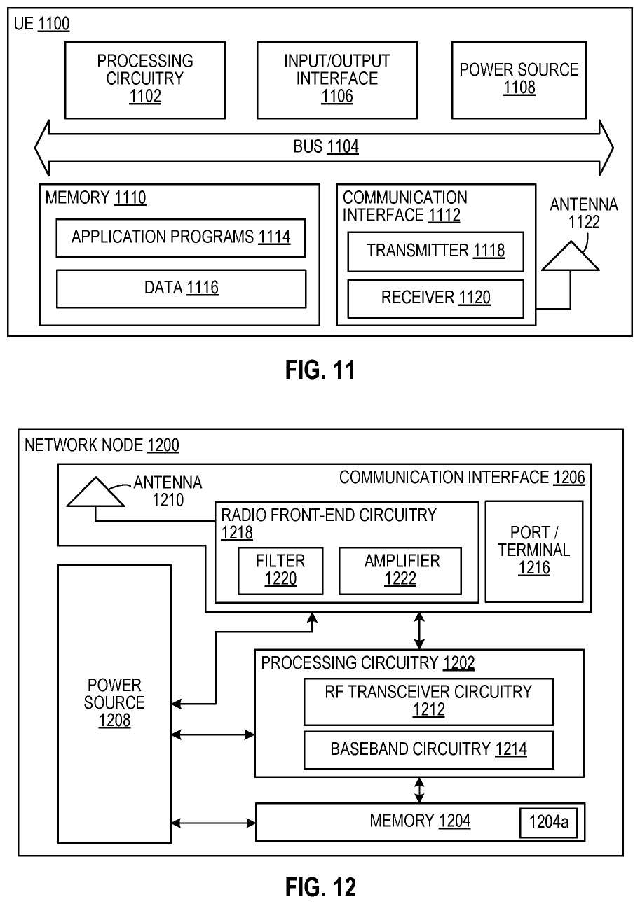

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions (collectively denoted computer program product 1204a) capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

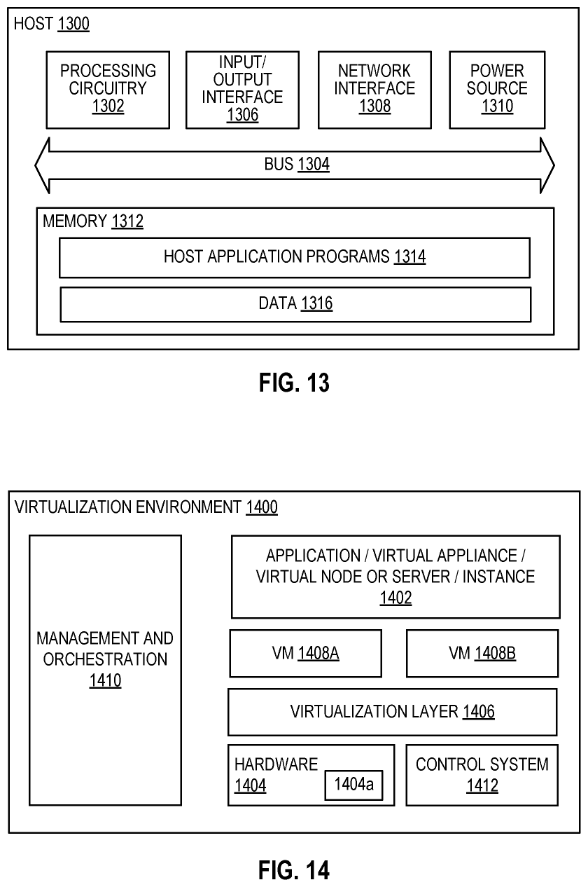

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions (collectively denoted computer program product 1404a) executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

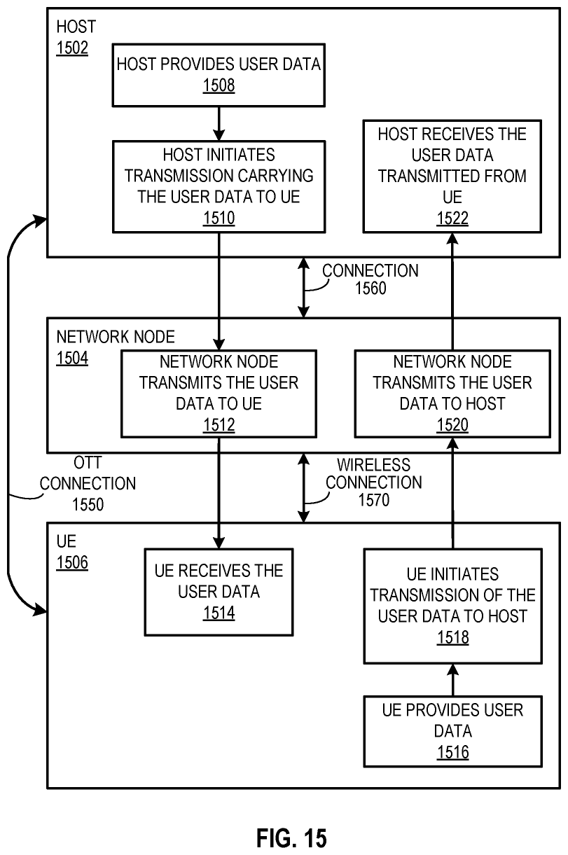

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, embodiments can facilitate machine learning (ML)-based CSI feedback using proprietary encoders and decoders, thereby improving multi-user MIMO (MU-MIMO) that relies on CSI feedback. Additionally, neither the UE's encoder nor the network's decoder needs to be standardized, and their respective architectures and/or parameters can be kept proprietary. The network can train, validate, and test CSI decoders using datasets generated from UL SRS channel estimates and UE CSI reports. These trained decoders can then facilitate replacing UE-specific UL SRS resources with cell-common DL CSI-RS resources, and thus can reduce reference signal transmission overhead. Due to these advantages, embodiments can improve the overall performance of MU-MIMO used to transmit DL data to multiple UEs concurrently. Accordingly, this can increase data rates, reduce data latency, and/or increase the number of concurrent users supported by the network, thereby increasing the value of OTT services that rely on the network to both end users and service providers.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above or by supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the present disclosure also include, but are not limited to, the following enumerated examples.
A1. A method for a radio access network (RAN) node configured to serve one or more user equipment (UEs) in the RAN, the method comprising:
   sending, to a UE, a message including a first configuration for performing measurements on downlink (DL) reference signals (RS) transmitted by the RAN node and reporting feedback representing a DL channel from the RAN node to the UE, based on the measurements;
   transmitting DL RS in accordance with the first configuration;
   receiving, from the UE, a report including the feedback representing the DL channel; and
   based on the feedback representing the DL channel, training one or more decoders of UE DL channel feedback for compatibility with corresponding one or more UE encoders of DL channel feedback.
A2. The method of embodiment A1, wherein training the one or more decoders comprises associating, with the respective decoders, respective identifiers that uniquely identify the respective UE encoders.
A3. The method of embodiment A2, further comprising receiving, from the UE, an indication of UE DL channel feedback encoding capabilities, wherein:
   the indication includes the one or more identifiers; and
   the first configuration is based on the indication.
A4. The method of embodiment A2, further comprising determining the one or more identifiers based on one or more of the following: UE vendor, UE model, UE chipset vendor, and UE chipset model.
A5. The method of any of embodiments A2-A4, further comprising:
   receiving, from a second RAN node, a training dataset for a plurality of decoders of UE DL channel feedback; and
   selectively training the one or more decoders based the received training dataset.
A6. The method of embodiment A5, wherein selectively training the one or more decoders comprises one of more of the following:
   training only the decoders having associated identifiers that match further identifiers included in the training dataset;
   training the decoders only based on portions of the training dataset associated with channel characteristics that are similar to channel characteristics measured by the RAN node; and
   training the decoders based on the received training dataset only when the second RAN node has an antenna array configuration that is similar to the RAN node's antenna array configuration.
A7. The method of any of embodiments A2-A6, wherein:
   the message also includes a second configuration for UE transmission of uplink (UL) RS;
   the method further comprises:
      measuring UL RS transmitted by the UE in accordance with the second configuration, and
      estimating an UL channel from UE to the RAN node based on the measurements of the UL RS; and
   training the one or more decoders is further based on the UL channel estimate.
A8. The method of embodiment A7, wherein training the one or more decoders comprises:
   determining an importance weight based on a duration between the UL RS transmitted by the UE and the DL RS transmitted by the RAN node, on which the feedback representing the DL channel is based; and
   based on the importance weight, adjusting the effect of the feedback representing the DL channel and the UL channel estimate on the training.
A9. The method of any of embodiments A7-A8, wherein:
   the second configuration identifies a plurality of symbols of a single timeslot for UE transmission of UL RS;
   measuring the UL RS comprises receiving the UL RS transmitted by the UE during the plurality of symbols using a respective plurality of different RAN node antennas; and
   estimating the UL channel comprises estimating a plurality of UL channels corresponding to the respective plurality of different RAN node antennas.
A10. The method of any of embodiments A7-A9, further comprising sending, to the UE, a downlink control information (DCI) command to initiate UE measurement of DL RS based on the first configuration and transmission of UL based on the second configuration.
A10a. The method of any of embodiments A7-A10, wherein the DL RS are channel state information (CSI) RS and the UL RS are sounding RS (SRS).
A11. The method of any of embodiments A1-A10a, wherein the one or more UE encoders of DL channel feedback are not trained during the training of the corresponding one or more decoders.
A12. The method of any of embodiments A1-A11, wherein the one or more UE encoders and the corresponding one or more decoders are part of respective one or more neural network-based autoencoders (AE).
A13. The method of any of embodiments A1-A12, wherein the feedback representing the DL channel is received as encoded by the one or more UE encoders.
A14. The method of any of embodiments A1-A13, further comprising, using the trained one or more decoders, decoding subsequently received UE DL channel feedback encoded by the corresponding one or more UE encoders.
B1. A method for a user equipment (UE) configured to communicate with a radio access network (RAN), the method comprising:
   receiving, from the RAN node, a message including a first configuration for performing measurements on downlink (DL) reference signals (RS) transmitted by the RAN node and reporting feedback representing a DL channel from the RAN node to the UE, based on the measurements;
   measuring DL RS transmitted by the RAN node in accordance with the first configuration;
   sending, to the RAN node, a report including feedback representing the DL channel, the feedback being based on the measurements of the DL RS,
   wherein the feedback representing the DL channel is used to train corresponding one or more RAN node decoders of DL channel feedback for compatibility with one or more UE encoders of DL channel feedback.
B2. The method of embodiment B1, wherein the one or more UE encoders are uniquely identified by respective one or more identifiers.
B3. The method of embodiment B2, further comprising sending, to the RAN node, an indication of UE DL channel feedback encoding capabilities, wherein:
   the indication includes the one or more identifiers; and
   the first configuration is based on the indication.
B4. The method of embodiment B2, wherein the one or more identifiers are implicit from one or more of the following: UE vendor, UE model, UE chipset vendor, and UE chipset model.
B5. The method of any of embodiments B2-B4, wherein:
   the message also includes a second configuration for UE transmission of uplink (UL) RS; and
   the method further comprises transmitting UL RS in accordance with the second configuration.
B6. The method of embodiment B5, wherein:
   the second configuration identifies a plurality of symbols, of a single timeslot, that correspond to a respective plurality of different RAN antennas; and
   the UL RS are transmitted in each of the plurality of symbols.
B7. The method of any of embodiments B5-B6, further comprising receiving, from the RAN, a downlink control information (DCI) command to initiate UE measurement of DL RS based on the first configuration and transmission of UL based on the second configuration, wherein transmitting the UL RS and measuring the DL RS are responsive to the DCI command.
B8. The method of any of embodiments B6-B7, wherein the DL RS are channel state information (CSI) RS and the UL RS are sounding RS (SRS).
B9. The method of any of embodiments B1-B8, wherein the one or more UE encoders of DL channel feedback are not trained during the training of the corresponding one or more RAN node decoders.
B10. The method of any of embodiments B1-B9, wherein the one or more UE encoders and the corresponding one or more decoders are part of respective one or more neural network-based autoencoders (AE).
B11. The method of any of embodiments B1-B10, wherein the feedback representing the DL channel is transmitted as encoded by the one or more UE encoders.
B12. The method of any of embodiments B1-B11, further comprising, after completion of the training of the corresponding one or more RAN node decoders, transmitting UE DL channel feedback encoded by the one or more UE encoders.
C1. A radio access network (RAN) node configured to serve one or more user equipment (UEs) in the RAN, the RAN node comprising:
   communication interface circuitry configured to communicate with the UEs; and
   processing circuitry operatively coupled to the communication interface circuitry, whereby the processing circuitry and the communication interface circuitry are configured to perform operations corresponding to any of the methods of embodiments A1-A14.
C2. A radio access network (RAN) node configured to serve one or more user equipment (UEs) in the RAN, the RAN node being configured to perform operations corresponding to any of the methods of embodiments A1-A14.
C3. A non-transitory, computer-readable medium storing computer-executable instructions that, when executed by processing circuitry of a radio access network (RAN) node configured to serve one or more user equipment (UEs) in the RAN, configure the RAN node to perform operations corresponding to any of the methods of embodiments A1-A14.
C4. A computer program product comprising computer-executable instructions that, when executed by processing circuitry of a radio access network (RAN) node configured to serve one or more user equipment (UEs) in the RAN, configure the RAN node to perform operations corresponding to any of the methods of embodiments A1-A14
D1. A user equipment (UE) configured to communicate with a radio access network (RAN), the UE comprising:
   communication interface circuitry configured to communicate with a RAN node; and
   processing circuitry operatively coupled to the communication interface circuitry, whereby the processing circuitry and the communication interface circuitry are configured to perform operations corresponding to any of the methods of embodiments B1-B12.
D2. A user equipment (UE) configured to communicate with a radio access network (RAN), the UE being further configured to perform operations corresponding to any of the methods of embodiments B1-B12.
D3. A non-transitory, computer-readable medium storing computer-executable instructions that, when executed by processing circuitry of a user equipment (UE) configured to communicate with a radio access network (RAN), configure the UE to perform operations corresponding to any of the methods of embodiments B1-B12.
D4. A computer program product comprising computer-executable instructions that, when executed by processing circuitry of a user equipment (UE) configured to communicate with a radio access network (RAN), configure the UE to perform operations corresponding to any of the methods of embodiments B1-B12.

1.-36. (canceled)

37. A method for a radio access network (RAN) node, the method comprising:
transmitting downlink (DL) reference signals (RS) in accordance with one or more configurations;
receiving, from each of one or more user equipment (UEs), feedback representing a DL channel from the RAN node to the UE, wherein the feedback is based on the UE's measurements of the transmitted DL RS and is encoded by one or more UE encoders that correspond to respective RAN node decoders;
for each of the one or more UEs, obtaining one or more measurements of uplink (UL) RS transmitted by the UE in accordance with the one or more configurations; and
training the one or more RAN node decoders based on the received feedback and the obtained UL RS measurements.

38. The method of claim 37, further comprising sending the one or more configurations to the one or more UEs, wherein each configuration includes the following: a first configuration for UE measurement of DL RS transmitted by the RAN node, a second configuration for UE transmission of UL RS, and an identifier of one of the UE encoders.

39. The method of claim 38, further comprising receiving, from each of the one or more UEs, an indication of UE DL channel feedback encoding capabilities, wherein one of the following applies:
the indication comprises at least one identifier of an encoder supported by the UE, including the one or more identifiers included in the respective configurations; or
encoders supported by the UE are indicated by one or more of the following: UE vendor, UE model, UE chipset vendor, and UE chipset model.

40. The method of claim 38, further comprising, for each of the one or more UEs, obtaining estimates of one or more UL channels from the UE to the RAN node based on the UL RS measurements, wherein training the one or more RAN node decoders is based on the UL channel estimates for the respective UEs.

41. The method of claim 40, wherein:
each second configuration identifies a plurality of symbols of a single timeslot for UE transmission of UL RS;
for each of the one or more UEs, obtaining one or more measurements of UL RS transmitted by the UE comprises receiving the UL RS transmitted by the UE during the plurality of symbols using a respective plurality of different RAN node antennas;
obtaining estimates of one or more UL channels from the UE to the RAN node comprises obtaining estimates of a plurality of UL channels corresponding to the respective plurality of different RAN node antennas; and
training the one or more RAN node decoders is based on the plurality of UL channel estimates.

42. The method of claim 37, further comprising:
receiving, from a second RAN node, a training dataset for a plurality of decoders of UE DL channel feedback; and
selectively training the one or more RAN node decoders based the received training dataset.

43. The method of claim 42, wherein selectively training the one or more RAN node decoders based the received training dataset comprises one of more of the following:
training only the RAN node decoders that correspond to encoder identifiers included in the received training dataset;
training the RAN node decoders only based on portions of the received training dataset that are associated with channel characteristics similar to channel characteristics measured by the RAN node; and
training the RAN node decoders based on the received training dataset only when the second RAN node has an antenna array configuration that is similar to the RAN node's antenna array configuration.

44. The method of claim 37, wherein training the one or more RAN node decoders based on the received feedback and the obtained UL RS measurements comprises, for each of the one or more UEs:
determining an importance weight based on a duration between transmitting the DL RS and obtaining the one or more measurements of UL RS transmitted by the UE; and
adjusting, in proportion to the importance weight, effect on the training of the UE's feedback representing the DL channel and of the measurements of UL RS transmitted by the UE

45. The method of claim 37, wherein one or more of the following applies:
the one or more UE encoders are not trained during the training of the corresponding one or more RAN node decoders;
the one or more UE encoders are fixed or configured as non-trainable; and
the one or more UE encoders and the corresponding one or more RAN node decoders are part of respective one or more neural network autoencoders (NNAEs).

46. The method of claim 37, further comprising, using a trained RAN node decoder, performing one or more of the following based on further feedback, from one of the UEs, that represents a DL channel from the RAN node to the UE and that is encoded by a UE encoder corresponding to the trained RAN node decoder:
determining one or more beam directions for the DL channel, and
estimating an UL channel from the UE to the RAN node.

47. The method of claim 37, wherein:
the one or more UE encoders include a plurality of UE encoders corresponding to a plurality of RAN node decoders;
the received feedback encoded by each UE encoder includes a different number of bits than the received feedback encoded by other UE encoders; and
one of the following applies:
the transmitting, receiving, obtaining, and training operations are performed for each of the RAN node decoders in sequence; or
transmitting the DL RS and obtaining the measurements of the UL RS transmitted by the UE are performed once for the plurality of RAN node decoders, wherein the received feedback is encoded by the plurality of UE encoders based on the UE's measurements of the DL RS.

48. A method for a user equipment (UE) configured to communicate with a radio access network (RAN), the method comprising:
obtaining one or more measurements of downlink (DL) reference signals (RS) transmitted by a RAN node in accordance with one or more configurations;
sending to the RAN node feedback representing a DL channel from the RAN node to the UE, wherein the feedback is based on the DL RS measurements and is encoded by one or more UE encoders that correspond to respective RAN node decoders; and
transmitting uplink (UL) RS in accordance with the one or more configurations.

49. The method of claim 48, wherein:
the feedback representing the DL channel is used to train the one or more RAN node decoders; and
the method further comprises, after the one or more RAN node decoders have been trained, transmitting further feedback that represents the DL channel and that is encoded by one of the UE encoders that corresponds to a trained RAN node decoder.

50. The method of claim 48, further comprising receiving the one or more configurations from the RAN node, wherein each configuration includes the following: a first configuration for UE measurement of DL RS transmitted by the RAN node, a second configuration for UE transmission of UL RS, and an identifier of one of the UE encoders.

51. The method of claim 50, further comprising sending to the RAN node an indication of UE DL channel feedback encoding capabilities, wherein one of the following applies:
the indication comprises at least one identifier of an encoder supported by the UE, including the one or more identifiers included in the respective configurations; or
encoders supported by the UE are indicated by one or more of the following: UE vendor, UE model, UE chipset vendor, and UE chipset model.

52. The method of claim 51, wherein:
the second configuration identifies a plurality of symbols of a single timeslot; and
the UL RS are transmitted in the plurality of symbols using respective UE antenna configurations that correspond to a plurality of different RAN node antennas.

53. The method of claim 48, wherein one or more of the following applies:
the one or more UE encoders are not trained during training of the corresponding one or more RAN node decoders;
the one or more UE encoders are fixed or configured as non-trainable; and
the one or more UE encoders and the corresponding one or more RAN node decoders are part of respective one or more neural network autoencoders (NNAEs).

54. The method of claim 48, wherein:
the one or more UE encoders include a plurality of UE encoders corresponding to a plurality of RAN node decoders;
the feedback encoded by each UE encoder includes a different number of bits than the feedback encoded by other UE encoders; and
one of the following applies:
the obtaining, sending, and transmitting operations are performed for each of the UE encoders in sequence; or
obtaining the measurements of the DL RS and transmitting the UL RS are performed once for the plurality of UE encoders, and the feedback is encoded by the plurality of UE encoders based on the measurements of the DL RS.

55. A radio access network (RAN) node comprising:
communication interface circuitry configured to communicate with user equipment(UEs); and
processing circuitry operatively coupled to the communication interface circuitry, whereby the processing circuitry and the communication interface circuitry are configured to:
transmit downlink (DL) reference signals (RS) in accordance with one or more configurations;
receive, from each of one or more user equipment, UEs, feedback representing a DL channel from the RAN node to the UE, wherein the feedback is based on the UE's measurements of the transmitted DL RS and is encoded by one or more UE encoders that correspond to respective RAN node decoders;
for each of the one or more UEs, obtain one or more measurements of uplink (UL) RS transmitted by the UE in accordance with the one or more configurations; and
train the one or more RAN node decoders based on the received feedback and the obtained UL RS measurements.

56. A user equipment (UE) configured to operate with a radio access network (RAN), the UE comprising:
communication interface circuitry configured to communicate with a RAN node; and
processing circuitry operatively coupled to the communication interface circuitry, whereby the processing circuitry and the communication interface circuitry are configured to:
obtain one or more measurements of downlink (DL) reference signals (RS) transmitted by the RAN node in accordance with one or more configurations;
send to the RAN node feedback representing a DL channel from the RAN node to the UE, wherein the feedback is based on the DL RS measurements and is encoded by one or more UE encoders that correspond to respective RAN node decoders; and
transmit uplink (UL) RS in accordance with the one or more configurations.
